(19) United States
(12) Patent Application Publication
(10) Pub. No.: US 2011/0005805 A1
(43) Pub. Date: Jan. 13, 2011

(54) CABLE

(75) Inventor: Hirotaka ESHIMA, Hitachi (JP)

Correspondence Address: FOLEY AND LARDNER LLP;SUITE 500, 3000 K STREET NW, WASHINGTON, DC, 20007, US

(73) Assignee: HITACHI CABLE, LTD.

(21) Appl. No.: 12/694,613

(22) Filed: Jan. 27, 2010

(30) Foreign Application Priority Data
Jul. 8, 2009 (JP) 2009-162100

(51) Int. Cl. H01B 7/18; H01B 7/02

(52) U.S. Cl. 174/114 R; 174/116

(57) ABSTRACT

A cable includes an inclusion containing stranded wire conductor that includes a plurality of stranded wires formed by twisting a plurality of conductor wires, and a plurality of thin diameter inclusions having an external diameter thinner than that of each of the stranded wires. The inclusion containing stranded wire conductor is formed by together twisting a plurality of the stranded wires and a plurality of the thin diameter inclusions so as to allow one of the thin diameter inclusions to be located between adjacent stranded wires of a plurality of the stranded wires.

The present application is based on Japanese patent application No. 2009-162100 filed Jul. 8, 2009, the entire contents of which are incorporated herein by reference.

### BACKGROUND OF THE INVENTION

1. Field of the Invention

This invention relates to a cable and, in particular, to a cable used for an environment where bending is repeatedly applied, such as robots and automobiles.

2. Description of the Related Art

For example, a cable for automobiles used in the environment where bending is repeatedly applied, such as an unsprung portion (a portion under a suspension device) of the automobiles where bending is repeated according to movement of wheels is needed to have not only high bending durability, but also, for example, high flexibility in terms of ease of routing work. However, it has been difficult to satisfy both high bending durability and high flexibility.

FIG. 4 is a cross-sectional view schematically showing a conventional cable.

The cable 41 includes a stranded wire conductor 43 formed by together twisting plural stranded wires (child stranded wires) 42 (FIG. 4 shows an example of seven stranded wires 42 twisted together) formed by twisting plural conductor wires together, and further includes an insulation layer 46, a shielding layer 47, a reinforcing braided layer 48 and a sheath 49 which are arranged sequentially from inside on the periphery of the stranded wire conductor 43.

Related arts to the invention are, e.g., JP-A-2001-266660 and JP-A-2004-063337.

However, none of the related arts discloses a cable for achieving both high bending durability and high flexibility.

### SUMMARY OF THE INVENTION

Therefore, it is an object of the invention to provide a cable that has both high bending durability and high flexibility by reducing contact between stranded wires so as to prevent the cable from abrasion or disconnection caused by bending.

(1) According to one embodiment of the invention, a cable comprises:

an inclusion containing stranded wire conductor comprising a plurality of stranded wires formed by twisting a plurality of conductor wires, and a plurality of thin diameter inclusions having an external diameter thinner than that of each of the stranded wires,

wherein the inclusion containing stranded wire conductor is formed by together twisting a plurality of the stranded wires and a plurality of the thin diameter inclusions so as to allow one of the thin diameter inclusions to be located between adjacent stranded wires of a plurality of the stranded wires.

In the above embodiment (1), the following modifications and changes can be made.

(i) The thin diameter inclusions are arranged surrounding not less than half of a periphery of each of the stranded wires in a sectional view of the cable.

(ii) The stranded wires are arranged nearly annularly in a cross sectional view of the cable.

(iii) The stranded wires comprises a stranded wire located inside the nearly annularly arranged stranded wires in the cross sectional view.

(iv) The thin diameter inclusions comprise a yarn twisted member formed by twisting fibrous yarns.

(v) The fibrous yarns comprise a staple fiber yarn.

(vi) The cable further comprises an insulation layer, a shielding layer and a sheath disposed sequentially from inside on a periphery of the inclusion containing stranded wire conductor, and

a reinforcing braided layer formed of a shock absorption fiber is disposed between the shielding layer and the sheath.

(vii) The conductor wires comprise a lubricating oil coated thereon.

(viii) The lubricating oil comprises a silicone oil.

Points of the Invention

According to one embodiment of the invention, a cable is constructed such that inclusions are located at least at a clearance of the shortest distance between two adjacent stranded wires (child stranded wires) in a stranded wire conductor of the cable, so that the physical mutual contact of the stranded wires can be reduced. Due to the reduction in physical mutual contact of the stranded wires, the abrasion or disconnection caused by bending can be significantly reduced in comparison with the conventional cable.

### BRIEF DESCRIPTION OF THE DRAWINGS

The preferred embodiments according to the invention will be explained below referring to the drawings, wherein:

FIG. 1 is a cross-sectional view schematically showing a cable according to one embodiment of the invention;

FIG. 2 is a cross-sectional view schematically showing a structure of a stranded wire used in one embodiment of the invention;

FIG. 3 is an explanatory view schematically showing a bending durability test; and

FIG. 4 is a cross-sectional view schematically showing a conventional cable.

### DETAILED DESCRIPTION OF THE PREFERRED EMBODIMENTS

The preferred embodiments according to the invention will be explained below referring to the drawings.

Prior to the present invention, the inventor has suggested, in Japanese patent application No. 2009-105307, a cable using an inclusion for having both high bending durability and high flexibility. This application discloses a structure that only plural stranded wires (i.e., child stranded wires) are twisted, wherein an inclusion (i.e., a central inclusion) at the center of the conductor is disposed for preventing abrasion or disconnection of wires caused when the stranded wires (child stranded wires) mutually contact and rub at a strong contact surface pressure in bending, so that the central inclusion deforms first such that the abrasion or disconnection of wires can be prevented by reducing the contact surface pressure caused between the stranded wires (child stranded wires).

However, even in the cable with the central inclusion, the stranded wires (child stranded wires) may contact mutually in physical aspect. Thus, the present invention aims at further securely preventing the abrasion or disconnection of wires in bending.

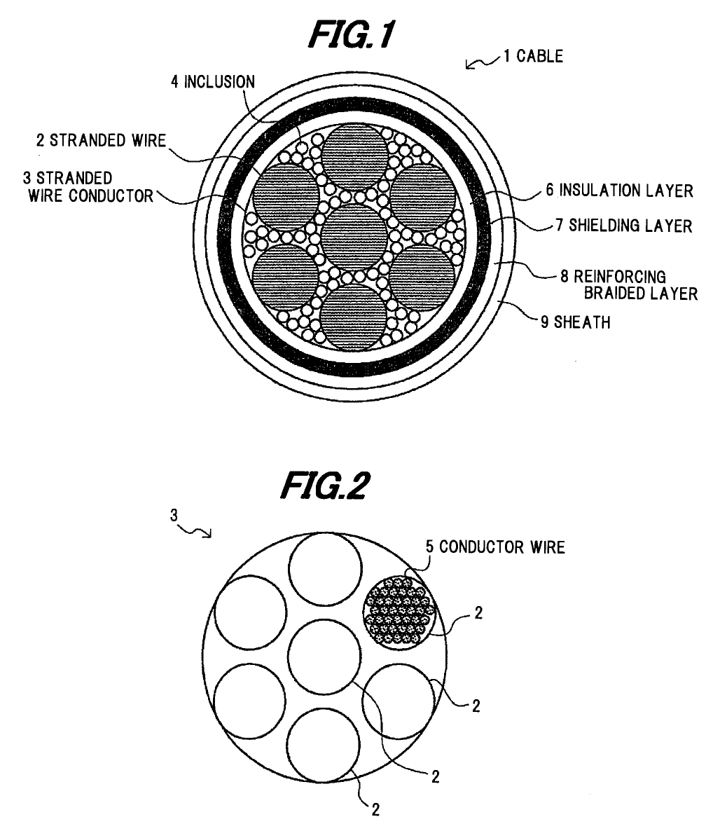

As shown in FIG. 1, the cable 1 according to the embodiment comprises an inclusion containing stranded wire conductor 3 including plural stranded wires (child stranded wires) 2 formed by twisting plural conductor wires and plural inclusions 4 having an external diameter thinner than that of the stranded wire 2. The inclusion containing stranded wire conductor 3 is formed by bundling and twisting the plural stranded wires 2 and the thin diameter inclusions 4 so as to allow the thin diameter inclusions 4 to locate between adjacent stranded wires 2 of the plural stranded wires 2.

As shown in FIG. 1, the inclusions 4 are arranged so as to surround not less than half of the periphery of each stranded wire 2 in a cross sectional view of the cable, and is a yarn twisted member formed by twisting fibrous yarns such as staple fiber yarns.

As shown in FIG. 2, the stranded wire (child stranded wire) 2 is formed by together twisting the plural conductor wires 5, and the stranded wire conductor 3 is formed by arranging the stranded wires 2 in annular form and further twisting them. Further, the number of the conductor wire 5 and the stranded wire 2 is not particularly limited.

The cable 1 shown in FIG. 1 further includes an insulation layer 6, a shielding layer 7, a reinforcing braided layer 8 and a sheath 9 arranged on a periphery of the stranded wire conductor 3 sequentially from the inner side. The reinforcing braided layer 8 arranged between the shielding layer 7 and the sheath 9 is a braid of a shock absorption fiber. Further, the presence or absence of the shielding layer 7 and the sheath 9 is not particularly limited.

Hereinafter, an operation and effect of the cable 1 will be explained.

The conventional cable 41 including no inclusion shown in FIG. 4 have no clearance to which the stranded wires (child stranded wires) 42 can escape in bending, so that the stranded wires 42 mutually contact and rub at a strong contact surface pressure in bending, whereby the abrasion or disconnection of wires may be caused. To solve this problem, the inventor has suggested, in Japanese patent application No. 2009-105307, the cable that the central inclusion deforms first such that the abrasion or disconnection of wires can be prevented by reducing the contact surface pressure caused between the stranded wires (child stranded wires). However, even in the cable with the central inclusion, the stranded wires (child stranded wires) may contact mutually in physical aspect, so that the abrasion or disconnection of wires may not be completely prevented.

By contrast, in the cable 1 of the embodiment, as shown in FIG. 1, the inclusions 4 are located at least at a clearance of the shortest distance between the two adjacent stranded wires (child stranded wires) 2 in the stranded wire conductor 3, so that the mutual contact of the stranded wires 2 can be physically reduced. Due to the physical reduction of the mutual contact of the stranded wires 2, the abrasion or disconnection caused by bending can be significantly reduced in comparison with the conventional cable.

Further, the cable 1 of the embodiment includes the inclusions 4, so that it can have large tensile strength.

In the embodiment, the stranded wire conductor 3 is formed by together twisting the seven stranded wires 2 in total that are obtained by arranging six stranded wires 2 nearly in annular form in a cross sectional view of the cable and further arranging one stranded wire 2 in the six stranded wires 2 arranged nearly in annular form in a cross sectional view of the cable.

As described above, the stranded wires 2 in the stranded wire conductor 3 are arranged nearly in annular form in a cross sectional view thereof, so that an outer shape of the cable can be formed in a circular shape. Also, the cable is formed in a circular shape so that a cable excellent in design can be realized.

Additionally, one stranded wire 2 is further arranged in the six stranded wires 2 arranged nearly in annular form in a cross sectional view thereof, so that a dead space of an interior portion surrounded by the six stranded wires 2 arranged nearly in annular form can be effectively used.

Further, in the embodiment, seven stranded wires 2 are used, but two, three or not less than seven stranded wires 2 can be also used, if within the scope of a technological idea of the invention.

Also, in the embodiment, the conductor wires 5 can be coated with lubricant oil such as silicone oil. If the conductor wires 5 can be coated with lubricant oil, the abrasion or disconnection can be reduced, even if the stranded wires (child stranded wires) 2 formed by twisting the conductor wires 5 physically contact together.

### Example

The cable 1 of Example having a cable structure shown in FIG. 1 and the cable 41 of Comparative Example having a cable structure shown in FIG. 4 were fabricated.

Example and Comparative Example have almost the same cable structure except that Example has the inclusions 4 and Comparative Example does not have the inclusions 4.

The stranded wires (child stranded wires) 2 were formed by twisting tin-plated annealed copper wires of 0.08 mm in diameter as the conductor wires 5. Further, an external diameter of the stranded wire 2 is 1.0 mm.

The stranded wire conductor 3 was formed by further twisting the stranded wires (child stranded wires) 2 formed by twisting the conductor wires 5 so as to allow at least one of the inclusions 4 to be located at least at a clearance of the shortest distance between the respective stranded wires 2 in order to prevent the contact of the stranded wires 2.

As the inclusions 4, a yarn twisted member formed by twisting fibrous yarns of staple fiber yarns was used. Further, an external diameter of the inclusion 4 is 0.1 mm.

On the other hand, the stranded wire conductor 43 was formed by further twisting the stranded wires (child stranded wires) 42 formed by twisting the conductor wires.

The insulation layers 6, 46 were formed of cross-linked polyethylene.

The shielding layers 7, 47 were formed of a tin-plated copper wire.

The reinforcing braided layers 8, 48 were formed of polyvinyl alcohol fibrous material (polyethylene terephthalate fibrous material or polyethylene-2, 6-naphthalate fibrous material can be also used).

The sheaths 9, 49 were formed of ethylene-propylene-diene rubber.

Both the cables 1, 41 have an external diameter of 10.0 mm.

Performance comparison was carried out by measuring bending durability and bending rigidity.

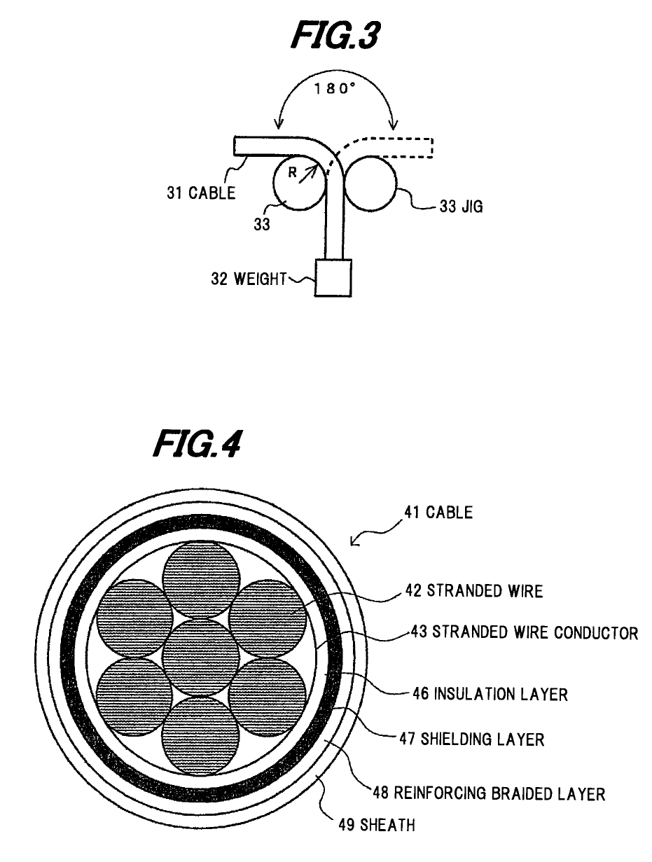

First, with regard to the cables of Example and Comparative Example, a bending durability test that the cables are bent more than once by 180 degrees from side to side with a bending radius R 30 (according to IEC (International Electrotechnical Commission) 60227-2 Electrical Appliances Technical Standard) was carried out. The test method is shown in FIG. 3.

As shown in FIG. 3, a weight 32 is fixed to a lower end of a cable 31 so as to apply a load to the cable 31, and the cable 31 is sandwiched between jigs 33, 33 having a curved surface for giving the bending radius R 30 to the cable 31. A cycle that a part of the cable 31 located at upper portion than the jigs 33, 33 is bent from a left-pointing horizontal position to a right-pointing horizontal position, and then the part of the cable 31 is returned to the left-pointing horizontal position is defined as one cycle. The cycle is repeated, and number of the cycles when at least one of the conductor wires 5 is broken is checked.

As shown in Table 1, in case of the cable 41 of Comparative Example, the conductor wires 5 were broken at ten thousand cycles of the bending, but in case of the cable 1 of Example, the conductor wires 5 were not broken even at half-million cycles of the bending, and it is clear that Example is remarkably excellent in bending durability in comparison with Comparative Example.

TABLE 1

| | Number of bending cycles |
|---|---|
| Example | Not less than half-million |
| Comparative Example | Ten thousand |

Next, with regard to the cables of Example and Comparative Example, bending rigidity to the bending radius R was measured.

Here, the “bending radius R” means a bending radius in a place where the cable is curved at a maximum when the cable is bent. The “bending rigidity” means an index showing difficulty in bending, which is represented as the product of longitudinal elastic modulus and geometrical moment of inertia. The bending radius R was set to 150, 80, 50 and 30 mm.

TABLE 2

| | Bending radius R (mm) | | | |
|---|---|---|---|---|
| | 150 | 80 | 50 | 30 |
| Comparative | 1 | 1 | 1 | 1 |
| Example | | | | |
| Example | 0.82 | 0.8 | 0.76 | 0.75 |

As shown in Table 2, when the bending rigidity in the cable 41 of Comparative Example is defined as 1, all of the bending rigidities in the cable 1 of Example became smaller than 1 of the bending rigidity in the cable 41 of Comparative Example. As seen from the above, the cable 1 of Example improved in flexibility than the cable 41 of Comparative Example.

From the above-mentioned results, it has become clear that the cable 1 of Example has higher bending durability and higher flexibility than the cable 41 of Comparative Example.

Further, in Example, the cable including both the shielding layer 7 and the sheath 9 was shown, in case of a cable including either of the layers, the same result can be obtained.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A cable, comprising:
an inclusion containing stranded wire conductor comprising a plurality of stranded wires formed by twisting a plurality of conductor wires, and a plurality of thin diameter inclusions having an external diameter thinner than that of each of the stranded wires,
wherein the inclusion containing stranded wire conductor is formed by together twisting a plurality of the stranded wires and a plurality of the thin diameter inclusions so as to allow one of the thin diameter inclusions to be located between adjacent stranded wires of a plurality of the stranded wires.

2. The cable according to claim 1, wherein the thin diameter inclusions are arranged surrounding not less than half of a periphery of each of the stranded wires in a sectional view of the cable.

3. The cable according to claim 1, wherein the stranded wires are arranged nearly annularly in a cross sectional view of the cable.

4. The cable according to claim 3, wherein the stranded wires comprises a stranded wire located inside the nearly annularly arranged stranded wires in the cross sectional view.

5. The cable according to claim 1, wherein the thin diameter inclusions comprise a yarn twisted member formed by twisting fibrous yarns.

6. The cable according to claim 5, wherein the fibrous yarns comprise a staple fiber yarn.

7. The cable according to claim 1, wherein the cable further comprises an insulation layer, a shielding layer and a sheath disposed sequentially from inside on a periphery of the inclusion containing stranded wire conductor, and
a reinforcing braided layer formed of a shock absorption fiber is disposed between the shielding layer and the sheath.

8. The cable according to claim 1, wherein the conductor wires comprise a lubricating oil coated thereon.

9. The cable according to claim 8, wherein the lubricating oil comprises a silicone oil.
